(19) United States
(12) Patent Application Publication
(10) Pub. No.: US 2003/0057018 A1
(43) Pub. Date: Mar. 27, 2003

(54) Retractable safety tether and harness assembly

(76) Inventors: William D. Dodson, Lebanon, IN (US); David D. Merrick, Cicero, IN (US)

Correspondence Address: BARNES & THORNBURG, 11 SOUTH MERIDIAN, INDIANAPOLIS, IN, 46204

(21) Appl. No.: 10/255,243

(22) Filed: Sep. 26, 2002

Related U.S. Application Data
(60) Provisional application No. 60/325,243, filed on Sep. 27, 2001.

(51) Int. Cl. A62B 1/16

(52) U.S. Cl. 182/3

(57) ABSTRACT

A retractable safety tether and harness assembly is configured to secure a user, supported at some elevation above the ground or other support surface by a user bearing structure, to a suitable support structure to thereby prevent the user from impacting the ground or other support surface in the event that the user is displaced from the user bearing structure. In one embodiment, the assembly includes a retractor, including a retractable web, mounted to the support structure via a retractor connecting arrangement, and a tether having one end configured for releasable connection to the retractable web via tether connecting arrangement and an opposite end connected to a safety harness worn by the user.

### CROSS-REFERENCE TO RELATED APPLICATIONS

This application claims priority to, and the benefit of, U.S. provisional patent application Ser. No. 60/325,243, filed Sep. 27, 2001, the disclosure of which is incorporated herein by reference.

### FIELD OF THE INVENTION

This invention relates generally to the field of safety restraint devices, and more specifically to safety restraint devices mountable to a tree, tree stand or other support structure and configured to prevent a user thereof from impacting the ground resulting from a fall from an adjacent user bearing structure.

### BACKGROUND AND SUMMARY OF THE INVENTION

The present invention is directed to a safety assembly that prevents a user, supported at some elevation above the ground or other support surface by a user bearing structure, from impacting the ground or other support surface in the event that the user is displaced from the user bearing structure. The assembly includes a retractor that is mounted to a support structure, and includes a retractable web suitably connected to one end of a tether. The opposite end of the tether is attached to a body harness worn by the user. If the user falls or otherwise becomes unsupported by the user bearing surface, the retractor locks to thereby maintain the user attached thereto via the tether and harness and to thereby prevent the user from falling to the ground. The tether may include a buffered tether system comprising a gathered excess of tether length that is controllably released as sufficient tension is applied to one end of the tether to thereby provide a mechanism for controllably lengthening the tether to lower the user toward the ground or other support structure.

A retractable safety harness and tether assembly is provided, comprising a retractor configured to be secured to a support structure, the retractor including a retractable web defining a tether connecting end, a tether having first and second opposite ends, and a restraint harness configured to be secured to a user and to the first end of the tether. A tether connecting arrangement is connected to the tether connecting end of the retractable web and releasably connectable to the second end of the tether. A retractor connecting arrangement secures the retractor to the support structure, and includes a support web secured to the support structure and a retractor mounting structure secured to the support web, wherein the retractor is mountable to the retractor mounting structure.

A tree scaling aid may include a first frame having a first end configured to engage a first side of a tree and a second opposite end, and a second frame having a first end configured to engage a second opposite side of the tree and a second opposite end movably connected to the second end of the first frame, the second frame movable relative to the first frame such that the first end of the second frame engages successively higher portions of the tree to aid in scaling the tree. The retractor may be mounted to the first frame between the first and second ends thereof, and the tether attached between the retractable web of the retractor and the restraint harness.

These and other features of the present invention will become more apparent from the following description of the illustrative embodiments.

### BRIEF DESCRIPTION OF THE DRAWINGS

FIG. 1 is a diagrammatic illustration of one embodiment of a retractable safety tether and harness assembly.

FIG. 2A is a diagrammatic illustration of one embodiment of the harness of FIG. 1.

FIG. 2B is a diagrammatic illustration of an alternate embodiment of the harness of FIG. 1.

FIG. 3A is a diagrammatic illustration of one embodiment of a connecting end of the tether of FIG. 2.

FIG. 3B is a diagrammatic illustration of an alternate embodiment of the connecting end of the tether of FIG. 2.

FIG. 4 is a diagrammatic illustration of one embodiment of the retractor and associated tether connecting arrangement for connecting the retractor to the harness tether as shown in FIG. 1.

FIG. 5 is a diagrammatic illustration of another embodiment of the retractor and associated tether connecting arrangement for connecting the retractor to the harness tether as shown in FIG. 1.

FIG. 6 is a diagrammatic illustration of one embodiment of the tether connecting arrangement of FIG. 5.

FIG. 7 is a diagrammatic illustration of one embodiment of a retractor mounting arrangement for mounting the retractor device to a tree as illustrated in FIG. 1.

FIG. 8 is a diagrammatic illustration of another embodiment of a retractor mounting arrangement for mounting the retractor device to a tree.

FIGS. 9A-9C are successive diagrammatic illustrations demonstrating the mounting of the retractor device to the retractor mounting arrangement of FIG. 8.

FIG. 10 is a diagrammatic illustration of an alternate embodiment of a retractable safety tether and harness assembly.

FIG. 11 is a diagrammatic illustration of one embodiment of a tree climbing aid having a retractor mounted thereto and configured for attachment to a safety tether and harness assembly.

### DESCRIPTION OF THE ILLUSTRATIVE EMBODIMENTS

For the purposes of promoting an understanding of the principles of the invention, reference will now be made to a number of embodiments illustrated in the drawings and specific language will be used to describe the same. It will nevertheless be understood that no limitation of the scope of the invention is thereby intended.

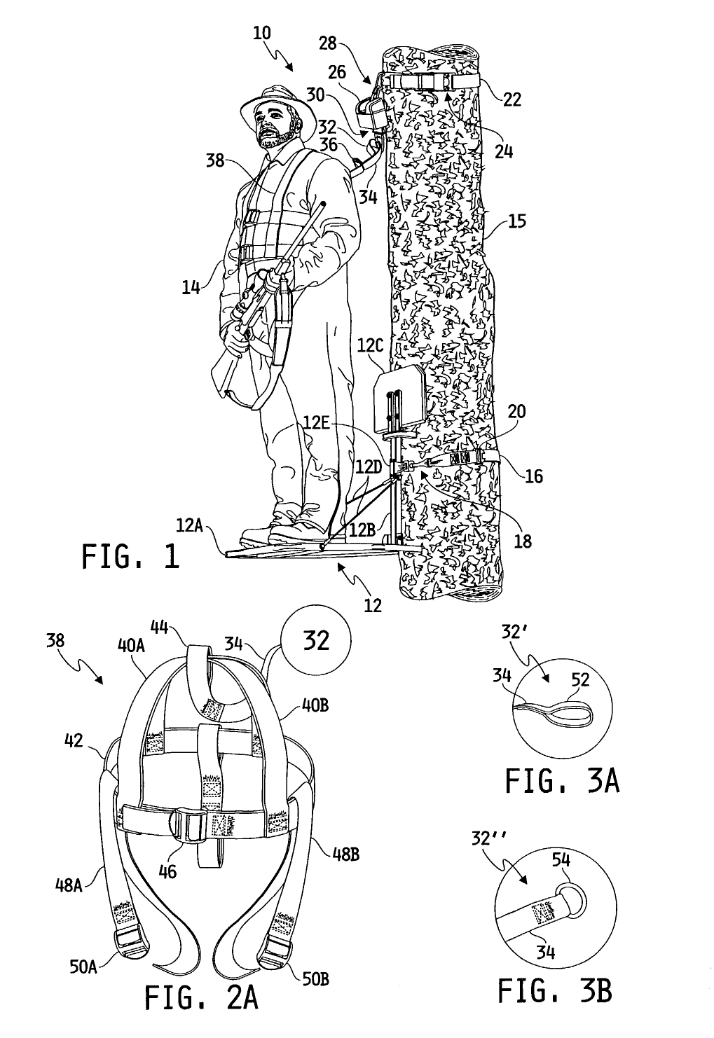

Referring to FIG. 1, a diagrammatic illustration of one illustrative embodiment of a retractable safety tether and harness assembly 10, in accordance with the present invention, is shown. Assembly 10 is generally configured to secure a user, supported at some elevation above the ground or other support surface by a user bearing structure, to a suitable support structure to thereby prevent the user from impacting the ground or other support surface in the event that the user is displaced from the user bearing structure. For purposes of demonstrating one illustrative implementation of assembly 10, the user bearing structure will be described herein as taking the form of a tree-mountable stand 12 of the type conventionally used by hunters and/or nature observers and the support structure will be described as comprising at least a portion of the tree 15 in which the stand is mounted. It is to be understood, however, that such structures are provided only by way of example, and are not intended to limit in any way the scope of the claims appended hereto. It is contemplated that the user bearing structure and support structure may each take varied forms, and the actual forms of such structures will generally be dictated by the specific applications of assembly 10.

In the embodiment shown in FIG. 1, a user 14 of assembly 10 is supported by a tree stand 12 mounted to a tree 15. The tree stand 12 may be any known tree-mountable stand configured to support user 14 in a conventional manner, and in the illustrated embodiment tree stand 12 includes a user-supporting platform 12A affixed adjacent a rear edge thereof to one end of an elongated post 12B, the opposite end of which is mounted to a movable seat 12C. Seat 12C may be pivotably or otherwise movably attached to post 12B such that it may be moved from its upright position illustrated in FIG. 1 to a support position that may be substantially parallel with platform 12A. In its support position, seat 12C is configured to support user 14 seated thereon. A pair of flexible support lines 12D are connected at one end to platform 12A adjacent a front edge thereof, and at an opposite end to post 12B. Post 12B includes a cap 12E affixable thereto via conventional means to form a slot therebetween sized to receive a web or belt 16 therethrough. Alternatively, cap 12E may be omitted, and the slot receiving the web 16 therethrough may be defined through or within post 12B. In any case, web 16 includes a conventional latching mechanism 18 configured to releasably join the two ends of the web 16, and a conventional web length adjusting mechanism 20 configured to vary the length of the web 16. The tree stand 12 is secured to the tree 15 by passing web 16 through the slot defined between post 12B and cap 12E, and then wrapping web 16 around the tree 15 and joining the two ends via latching mechanism 18. Thereafter, the web length adjusting mechanism 20 is manipulated in a known manner to shorten the length of web 16, forcing the rear edge of platform 12A, post 12B against the tree 15 and thereby securing the tree-stand 12 to the tree 15. The tree stand 12 may be formed of any of a variety of materials including, but not limited to, any single one or combination of wood, plastic, metal or the like.

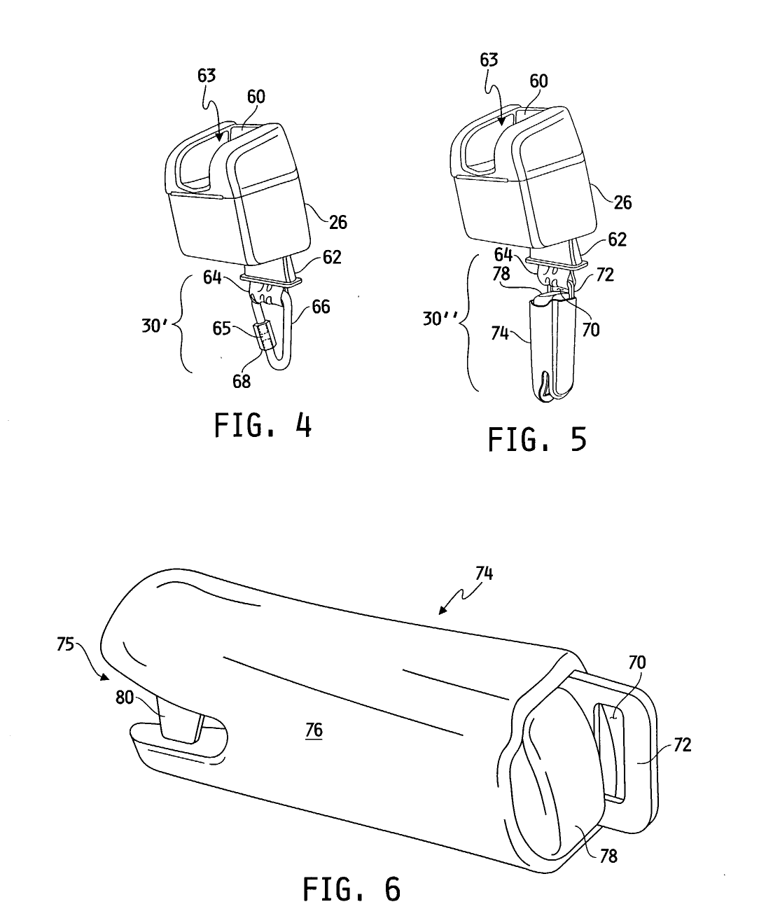

In the embodiment illustrated in FIG. 1, assembly 10 includes a second web or belt 22 including a web length adjusting mechanism 24 of known construction for adjustably securing web 22 to the tree 15, wherein web 22 will typically be secured to and about the tree 15 generally above the tree stand 12. A retractor 26 is releasably securable to the web 22 via a retractor mounting structure 28, wherein the web 22 and retractor mounting structure 28 generally define a retractor mounting arrangement. The retractor 26 includes a retractable web 64 (see FIGS. 4 and 5) that is secured to one end 32 of a tether 34 via a tether connecting arrangement 30. The opposite end of the tether 34 is attached to a restraint harness 38 configured to be worn by the user 14. In one embodiment, tether 34 includes a buffered tether system 36 between its opposing ends, wherein the buffered tether system comprises, in one embodiment, a gathered excess of tether length that is controllably released as sufficient tension is applied to one end of the tether to thereby provide a mechanism for controllably lengthening the tether to lower the user toward the ground or other support structure. For example, buffered tether system 36 may comprise a bundle of excess tether sewn or otherwise attached together in such a manner that the stitching pulls apart to release the excess tether under the weight of user 14 being supported only by tether 34, such as if user 14 falls or steps off platform 12A or seat 12C. In another embodiment, the buffered tether system 36 may comprise a bundle of excess tether releasably bundled together in a manner that allows user 14 to controllably release the bundle to thereby controllably lengthen the tether 34 to controllably lower the user 14 to the ground or other support structure. It is to be understood that inclusion of the buffered tether system 36 is optional, and embodiments of assembly 10 are accordingly contemplated in which the buffered tether system 36 is omitted.

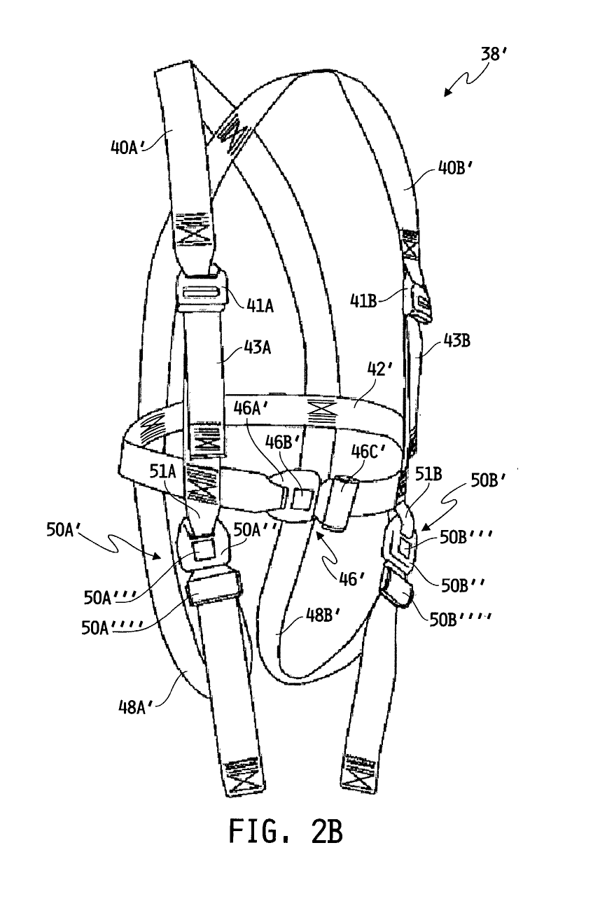

Referring now to FIG. 2A, one illustrative embodiment of the harness 38 of FIG. 1 is shown. Harness 38 includes a pair of shoulder straps 40A and 40B attached to, or integral with, a belt portion 42 having a belt length adjustment mechanism 46 for adjusting the length of the belt 42. Straps 40A and 40B and belt 42 are configured to be secured about the shoulder and waist areas respectively of the user 14 in a known manner. Harness 38 further includes a pair of leg straps 48A and 48B looped over the belt 42, and including strap length adjustment mechanisms 50A and 50B at respective ends thereof. Straps 48A and 48B are configured to be secured to belt 42 and the upper leg areas of the user 14 in a known manner.

A first end 44 of the tether 34 is attached to the harness 38, and in FIG. 1 end 44 is shown as including portion of tether 34 sewn or otherwise attached to itself to form a loop. Alternatively, end 44 may include additional loops, and/or may have one or more rings, hooks or similar structure attached thereto configured for attachment to harness 38. Alternatively still, end 44 of the tether 34 may have one or more clips, caribeeners, tongue and buckle arrangements or the like configured to releasably attach end 44 of tether to harness 38. In any case, end 44 of tether 34 is illustrated in FIG. 1 as being attached to shoulder straps 40A and 40B, although it is to be understood that end 44 may alternatively or additionally be connected to the belt 42 and/or either of the leg straps 48A and 48B. In the embodiment shown, the tether 34 and harness 38 are each formed of conventional restraint webbing, although other materials are contemplated including, but not limited to, any one or combination of leather, nylon, vinyl, fabric or the like.

The second free end 32 of tether 34 may take the general form of any connector or connectable arrangement, and two specific examples of the second end of the tether 24 are illustrated in FIGS. 3A and 3B. Referring to FIG. 3A, the second free end 32′ of tether 34 is formed by sewing or otherwise attaching an end portion of the tether 34 to itself adjacent the second end thereof to form a tether loop 52. Referring to FIG. 3B, the second free end 32″ of tether 34 may comprise a metal ring 54 affixed to tether 34 via any known technique therefore. Ring 52 may take any desired shape such as, for example, an “O” shape, a “D” shape, or the like. It will be appreciated that while FIGS. 3A and 3B illustrate two specific examples of the free end 32 of tether 34, any known connector or connector arrangement may alternatively be used without detracting from the scope of the present invention.

Referring now to FIG. 2B, an alternate embodiment 38′ of the harness 38 of FIG. 1 is shown. Harness 38′ includes a first pair of shoulder straps 40A′ and 40B′ and a second pair of shoulder straps 43A and 43B attached to, or integral with, a belt portion 42′ having a releasable buckle arrangement 46′ attached thereto. Shoulder straps 40A′ and 43A are attached via a conventional strap adjustment mechanism 41A, and shoulder straps 40B′ and 43B are attached via an identical conventional strap adjustment mechanism 41B. The lengths of shoulder straps 43A and 43B may be adjusted in a known manner via shoulder strap length adjustment mechanisms 41A and 41B respectively. In the embodiment of harness 38′ illustrated in FIG. 2B, tether 34 and its attachment to harness 38′ has been omitted for brevity, although it is to be understood that tether 34 may be attached to harness 38′ using any one or more of the techniques described hereinabove with respect to FIG. 2A. In any case, releasable buckle arrangement 46′ includes a conventional buckle mechanism 46A′ and tongue mechanism 46C′, wherein buckle mechanism 46A′ and tongue mechanism 46C′ are conventionally configured such that tongue mechanism 46C′ engages buckle mechanism 46C′ as tongue mechanism 46C′ is received within buckle mechanism 46A′. Buckle 46A′ includes a conventional tongue release button or other mechanism 46B′ that may be depressed to release tongue mechanism 46C′ from buckle 46A′ in a known manner. The length of belt 42′ may be adjusted in a known manner by pulling one end of belt 42′ (not shown) through tongue mechanism 46C′. Straps 40A′ and 40B′ and belt 42′ are configured to be secured about the shoulder and waist areas respectively of the user 14 in a known manner.

Harness 38′ further includes a first pair of leg straps 48A′ and 48B′ attached to or integral with belt 42′, wherein straps 48A′ and 48B′ may be extensions of shoulder straps 40A′ and 40B′ respectively as illustrated in FIG. 2B, or may alternatively be separate from, but proximate to, shoulder straps 40A′ and 40B′. Harness 38′ further includes a second pair of leg straps 51A and 51B attached to or integral with belt 42′ adjacent or proximate to releasable buckle arrangement 46′, and each pair 48A′-51A and 48B′-51B of leg straps include releasable buckle arrangements 50A′ and 50B′ respectively attached thereto. Releasable buckle arrangements 50A′ and 50B′ may be structurally and functionally identical to releasable buckle arrangement 46′ described hereinabove, wherein elements 50A″ and 50B″ correspond to buckle mechanism 46A′, elements 50A″″ and 50B″″ correspond to tongue mechanism 46C′, and elements 50A′″ and 50B′″ correspond to tongue release button or other mechanism 46B′. Straps 48A′ and 48B′ are configured to be secured to belt 42′ and the upper leg areas of the user 14 in a known manner. In the embodiment shown, harness 38′ is formed of conventional restraint webbing, although other materials are contemplated including, but not limited to, any one or combination of leather, nylon, vinyl, fabric or the like. In any case, the illustrated configuration of harness assembly 38′ provides for quick entry and release into and out of harness assembly 38′.

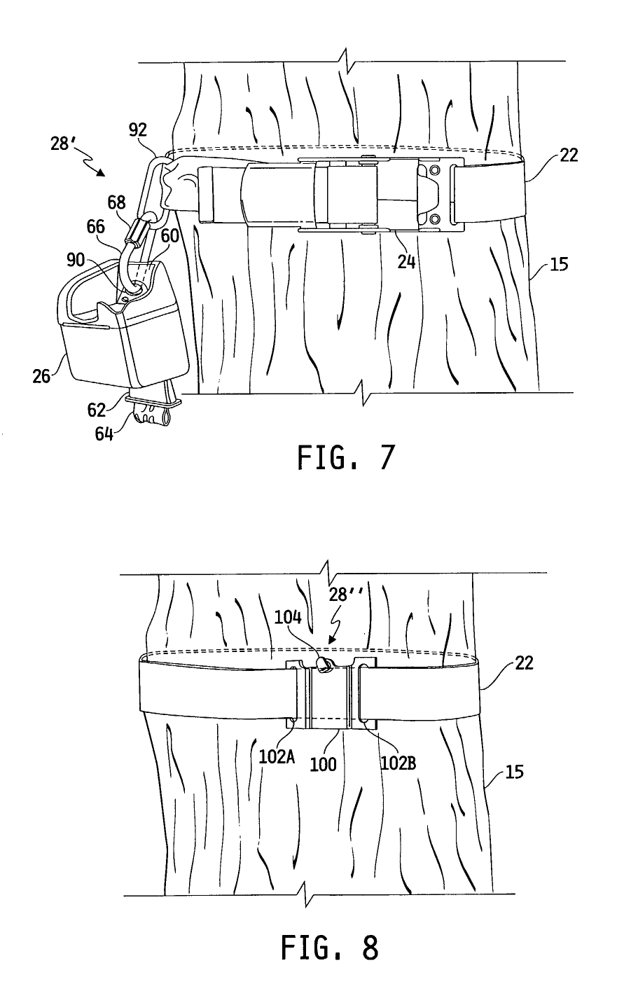

Referring now to FIGS. 4 and 5, some of the features of one illustrative embodiment of the retractor 26 are shown. At one end thereof, retractor 26 defines a recess or channel 63 therein terminating at a back wall 60, wherein back wall 60 forms or includes at least a portion of a frame configured for mounting retractor 60 to a retractor connecting arrangement as will be described in greater detail hereinafter with respect to FIGS. 7-9C. Retractor 26 includes a retractable web 64 having one end connected to a known retractor mechanism carried within retractor 26 (not shown), and having an opposite tether connecting end extending from a retractor web guide 62. In one embodiment, retractor 26 includes about 3-4 feet of retractable web 64, although it will be appreciated that retractor 26 may alternatively be configured to include more or less length of retractable web 64. In the embodiment illustrated in FIGS. 4 and 5, the tether connecting end of the retractable web 64 is sewn or otherwise attached to web 64 adjacent to the tether connecting end to form a loop of web material. While the retractor mechanism carried by retractor 26 and connected to the retractable web 64 may be any known retractor mechanism, one particular retractor suitable for use with assembly 10 is described in U.S. Pat. No. 5,622,327, the disclosure of which is incorporated herein by reference. In any case, it is desirable for the retractor 26 to be a locking or inertial retractor operable to allow free movement of the retractable web 64 relative to retractor 26 as long as this movement occurs at a rate less than a threshold rate, and to lock or inhibit further movement of the retractable web 64 relative to the retractor 26 when this movement occurs at a rate greater than the threshold rate.

Although not illustrated in the drawings, it is contemplated that retractor 26 may be configured to perform a function similar to that of the buffered tether system 36 described hereinabove. For example, retractor 26 may be configured to include several feet (e.g., 20-40) of the retractable web 64, and may further include a mechanism for controllably releasing web 64 from retractor 26 to allow the user 14 to be lowered from an elevated position to the ground or other support surface via web 64. In one embodiment, for example, retractor 26 may be configured with a mechanical delay mechanism operable to slowly release the length of web 64 therefrom after initially locking web 64 thereto as described hereinabove in the event that user 14 falls from, or otherwise becomes unsupported by platform 12A and/or seat 12C. Alternatively, retractor 26 may be configured to include a mechanical release mechanism, actuatable by the user 14, that allows the user to controllably release the length of web 64 from the retractor 26. Those skilled in the art will recognize other suitable web release mechanisms configurable to controllably release web 64 from the retractor 26 to perform the function just described, and such other web release mechanisms are intended to fall within the scope of the present invention.

FIGS. 4 and 5 also illustrate two different examples 30′ and 30″ of the tether connecting arrangement 30 illustrated in FIG. 1 for releasably connecting the second end 32 of the tether 34 to the retractable web 64 of the retractor 26. It is to be understood that the examples detailed in FIGS. 4 and 5 are provided only for purposes of illustration, and that other releasably connectable tether connecting arrangements are contemplated. In the first example shown in FIG. 4, tether connecting arrangement 30′ includes a caribeener 66 of known construction having two adjacent ends disposed in opposing relationship and defining a space 65 therebetween sized to receive both the looped portion of the retractable web 64 and the second end 32 of the tether 34 therein. A nut 68 is releasably connectable to each of the adjacent ends of the caribeener 66 to thereby trap the looped portion of the retractable web 64 and the second end 32 of the tether 34 within the caribeener 66 as illustrated in FIG. 1. In one embodiment, the adjacent ends of the caribeener 66 are externally threaded, and the nut 68 is internally threaded in complementary fashion such that nut 68 is configured to threadingly engage each of the adjacent ends of caribeener 66 to thereby block space 65.

In the second example shown in FIGS. 5 and 6, tether connecting arrangement 30″ includes an articulating connector 74 having a frame portion 72 at one end defining a slot 70 sized to receive the looped portion of the retractable web 64 therein to thereby secure the articulating connector 74 to the retractable web 64 as shown. Connector 74 includes a housing 76 defining a mouth 75 facing generally away from the slot 70 such that mouth 75 likewise faces generally away from the retractor 26 when mounted thereto as illustrated in FIG. 5. Connector 74 further defines an articulating jaw 80 disposed within the mouth 75, and an actuator 78 adjacent to the slot 70 for articulating the jaw 80 between open and closed positions. The mouth 75 is sized to receive therein the second end 32 of tether 34 when the articulating jaw 80 is opened by depressing actuator 78, and when the articulating jaw 80 is closed by releasing actuator 78 the second end 32 of tether 34 is trapped within the mouth 75 and inhibited by the closed jaw 80 from escaping mouth 75.

While the present invention contemplates that articulating connector 74 may be any known articulating connector operable similarly as just described, a number of embodiments of one particular articulating connector suitable for use as articulating connector 74 are described in co-pending U.S. application Ser. No. 09/472,258, in co-pending U.S. application Ser. No. 60/307,899, and in co-pending U.S. application Ser. No. 10/206,603, the disclosures of which are each incorporated herein by reference.

Referring now to FIG. 7, one illustrative embodiment 28′ of the retractor mounting structure 28 illustrated in FIG. 1 is shown. Retractor mounting structure 28′ includes a ring 92 of known construction sized to receive web 22 therethrough prior to attaching or affixing web 22 to the tree 15. It is to be understood that although ring 90 is illustrated in FIG. 7 is generally “O” shaped, ring 90 may alternatively be formed as any closed shape sized to receive web 22 therethrough. In any case, once web 22 is attached or affixed to the tree 15 via web adjusting mechanism 24, ring 92 is likewise affixed to the tree 15. Wall 60 of retractor 26 defines a slot or bore 90 therethrough sized to receive a leg of a caribeener 66 therethrough as illustrated in FIG. 7, wherein caribeener 66 may be identically as described hereinabove with respect to FIG. 4 and the various features of which are identified by like reference numbers. The space 65 defined between the opposing, adjacent ends of caribeener 66 (see FIG. 4) is sized to receive ring 92 therein, and the cap 68 is affixed to opposing ends of caribeener 66 after caribeener 66 is received within slot or bore 90 and after caribeener 66 receives ring 92 therein, to thereby secure retractor 26 to the tree 15 as illustrated in FIGS. 1 and 7.

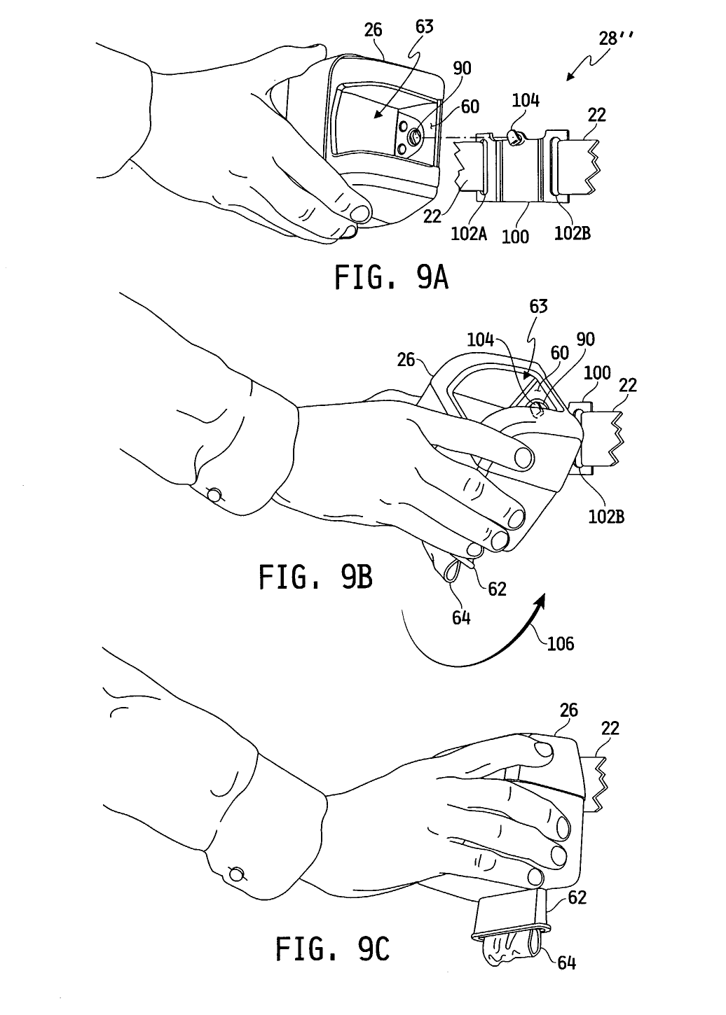

Referring now to FIGS. 8-9C, an alternate embodiment 28″ of the retractor mounting structure 28 generally illustrated in FIG. 1 is shown. Retractor mounting structure 28″ includes a bracket 100 defining a pair of slots 102A and 102B adjacent opposing edges thereof, wherein slots 102A and 102B are each sized to receive web 22 therethrough. Web 22 is threaded through slots 102A and 102B, and then wrapped around and affixed to tree 15 at a suitable location via web adjusting mechanism 24 to thereby secure bracket 100 to the tree 15 as illustrated in FIG. 8. Bracket 100 may be formed of one or more conventional materials, example of which include) but are not limited to, wood, metal, plastic, fabric, or the like.

Bracket 100 defines a protrusion 104 between slots 102A and 102B and generally adjacent to one edge thereof, which extends generally outwardly and away from bracket 100. Protrusion 104 is sized to be received within the slot or bore 90 defined through the back wall 60 of the retractor 26 to thereby mount retractor 26 to bracket 100. In one embodiment, as illustrated most clearly in FIGS. 8 and 9A, the protrusion 104 comprises a portion of the bracket 100 that extends first outwardly away from bracket 100 an then generally parallel to bracket 100 at an acute angle relative to the longitudinal axis of slots 102A and 102B to thereby form a slot between the protrusion 104 and the bracket 100. In this embodiment, the slot or bore 90 defined through the back wall 60 of the retractor 26 is shaped complementarily to that of the protrusion 104 such that the protrusion 104 may only be received within the slot or bore 90 when the retractor 26 is rotated relative to bracket 100 as illustrated in FIG. 9A. Once the protrusion 104 is received within the slot or bore 90, the retractor 26 is then rotated in the direction of arrow 106 (see FIG. 9B) to the position illustrated in FIG. 9C to thereby secure the retractor 26 to the bracket 100 and, in turn, to the tree 15.

It is to be understood that the examples of the retractor connector arrangements and retractor mounting structures 28′ and 28″ detailed in FIGS. 7-9C are provided only for purposes of illustration, and that other retractor connector arrangements and/or retractor mounting structures are contemplated. For example, retractor 26 may alternatively be mounted directly to belt 22 via a conventional bolt/nut arrangement or via any other known mounting system, wherein any such alternate mounting system is intended to fall within the scope of the present invention. Alternatively still, bracket 100 may be configured to define a slot therethrough, and retractor 26 may be configured to have a bolt, rod, shaft or other elongated member extending rearwardly from the back wall 60 of retractor 26 with a head or other enlarged member affixed to, or integral with, the free end thereof. In this embodiment, the slot defined through bracket 100 may have a portion defining a first width configured to receive the head and a portion of the shaft attached to the retractor 26 therethrough, and another portion defining a second smaller width configured to receive only the shaft portion therein. Retractor 26 may thus be mounted to bracket 100 with the reduced-width portion of the slot trapped between the head and shaft of the elongated member affixed to retractor 26.

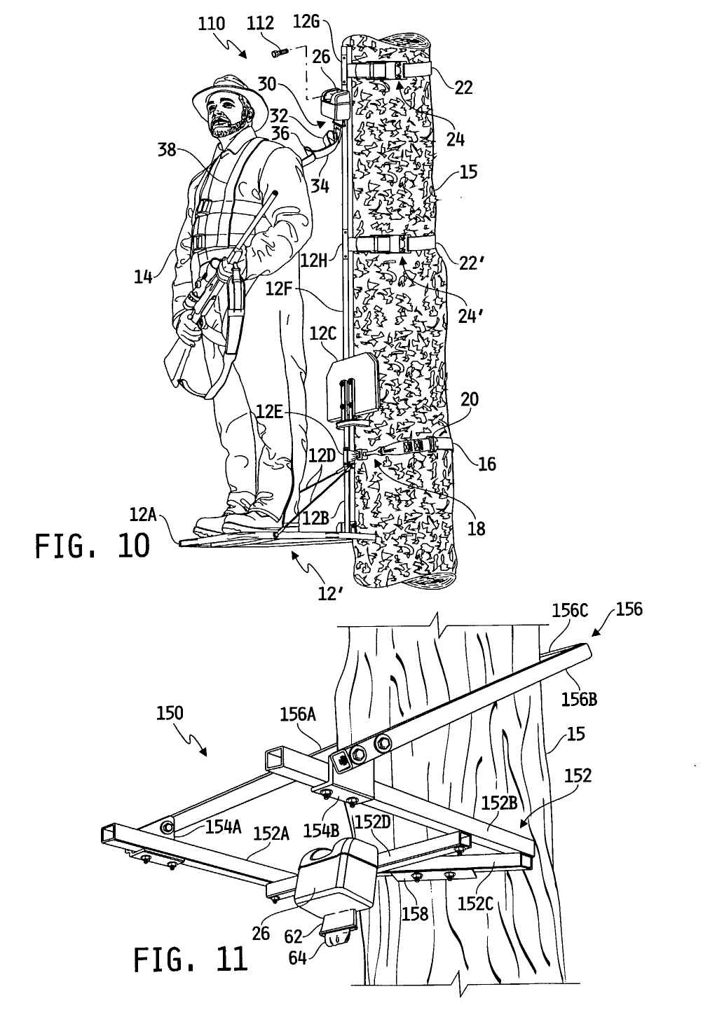

Referring now to FIG. 10, a diagrammatic illustration of an alternate embodiment of a retractable safety tether and harness assembly 110 is shown. Assembly 110 is identical in many respects to the assembly 10 described and illustrated hereinabove, and like reference numbers are accordingly used to identify like components. Unlike assembly 10, tree stand 12′ in assembly 110 includes an additional post 12F, similar or identical to post 12B, attached to seat 12C and extending upwardly therefrom. Post 12F includes a cap 12G, similar or identical to cap 12E, affixable thereto via conventional means to form a slot therebetween sized to receive web 22 therethrough. Alternatively, cap 12G may be omitted, and the slot receiving the web 22 therethrough may be defined through post 12F. In any case, web 22 is passed through the slot defined between the post 12F and cap 12G, and then wrapped around the tree 15 and adjusted as described hereinabove to thereby secure post 12F to the tree 15. Post 12F may further include a second cap 12H, similar or identical to caps 12E and 12G, affixable thereto via conventional means to form a slot therebetween sized to receive another web 22′ therethrough, wherein web 22′ may be identical to web 22 and include a web adjusting mechanism 24′ identical to mechanism 24 described hereinabove. Alternatively, cap 12H may be omitted, and the slot receiving the web 22′ therethrough may be defined through post 12F. In any case, web 22′ is passed through the slot defined between the post 12F and cap 12H, and then wrapped around the tree 15 and adjusted as described hereinabove to thereby secure post 12F to the tree 15 between belts 16 and 22. In this embodiment, the retractor 26 is mounted directly to the post 12F, and the mounting structure 28 of FIG. 1 may therefore be omitted. It will be appreciated that the retractor 26 may be releasably mounted to post 12F using various known techniques, including any one or more of the techniques described hereinabove, and any such techniques are intended to fall within the scope of the present invention. For example, plate 100 may be mounted to post 12F, and the retractor 26 may then be mounted to plate 100 as described herein. As another example, post 12F may be provided with a bore (not shown) sized to receive a fixation member 112. In this embodiment, as illustrated in FIG. 10, fixation member 112 is directed through slot or bore 90 defined through the back wall 60 of the retractor 26 and received within the bore provided in the post 12F to thereby secure the retractor 26 to the post 12F. The fixation member 112 and corresponding bore provided in the post 12F may or may not be threaded. As yet another example, fixation member 112 may be mounted directly to post 12F, and the retractor 26 may be mounted to post 12F by sliding the slot or bore 90 over the fixation member 112 and secured thereto via an appropriate cap, key or threaded nut. As still a further example, a closed ring or similar structure may be affixed to post 12F, and retractor 26 may be affixed to such a structure via a caribeener as described hereinabove with respect to FIG. 7. Other examples will occur to those skilled in the art, wherein such other examples will generally be dictated, at least in part, by the particular application. Those skilled in the art will recognize that retractor 26 may alternatively be mounted to another portion of tree stand 12′ (or of tree stand 12) including any of the support structures 12A, 12B and/or 12C, and such other tree stand mounting arrangements are intended to fall within the scope of the present invention.

Referring to FIG. 11, one illustrative embodiment of a tree scaling aid 150 having a retractor 26 releasably mounted thereto using any one or more of the mechanisms described hereinabove, and configured for attachment to a safety tether and harness assembly 10 or 110, is shown. Tree scaling aid 150 includes a first frame 152 comprised generally of first and second elongated members 152A and 152B connected to an elongated cross member 152C to generally form an open-ended rectangle or square. A plate 158 is affixed to a bottom edge of member 152C to enhance engagement of member 152C with one side of the tree 15. A second cross member 152D is connected between elongated members 152A and 152B, and retractor 26 is mounted to cross member 152D via any known mounting mechanism including any one or more of the retractor mounting and/or attachment techniques described hereinabove.

A second frame 156 includes first and second elongated members 156A and 156B joined at first ends thereof by an elongated cross member 156C, and movably attached at second opposite ends thereof to respective ones of the first and second elongated members 152A and 152B via articulating brackets 154A and 154B respectively. In one embodiment, elongated members 156A and 156B are pivotably mounted to brackets 154A and 154B respectively, although other movable structures are contemplated. In any case, frame 156 is configured to be disposed about the tree 15 before connection to brackets 154A and 154B such that the first end of the second bracket 156 engages a second side of the tree 15 opposite to that engaged by frame member 152C. Second frame 156 is then movable relative to the first frame 152 such that the first end of the second frame defined by member 156C engages successively higher portions of one side of the tree while frame member 152C is braced against the opposite side of the tree 15 to thereby aid in scaling the tree 15. The retractable web 64 of the retractor 26 is connectable as described hereinabove to the tether 34 and harness 38. Although not shown in FIG. 11, tree stand 12 or 12′ illustrated in FIGS. 1 and 10 respectively, may then be mounted to the tree 15 below tree scaling aid 150 to provide a weight bearing surface upon which the user may sit or stand.

In any of the embodiments illustrated and described herein, the retractor 26 is a locking retractor and is operable to sense displacement of the user 14 from the tree stand supporting surface 12A such as would occur when the user 14 falls from the tree stand 12. When this occurs, the retractor 26 is operable to lock and inhibit further movement of the retractable web 64 relative to the retractor 26, thereby supporting the user 14 therefrom via the harness 38 and tether 34. The tether 34 is typically sized in length such that the user 14 is suspended above the ground or other supporting structure in the event that the user falls from the tree stand 12 and is supported by the retractable safety tether and harness assembly 10 or 110.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A retractable safety harness and tether assembly, comprising:
a retractor configured to be secured to a support structure, said retractor including a retractable web defining a tether connecting end;
a tether having first and second opposite ends;
a restraint harness configured to be secured to a user, said first end of said tether attached to said restraint harness; and
a tether connecting arrangement connected to said tether connecting end of said retractable web and releasably connectable to said second end of said tether.

2. The assembly of claim 1 wherein said retractor is a locking retractor responsive to predefined movement of said retractable web relative to said retractor to inhibit further movement of said retractable web relative to said retractor.

3. The assembly of claim 1 wherein said tether includes a gathered excess of tether between said first and second opposite ends thereof, said gathered excess of tether releasable to thereby increase a length of said tether.

4. The assembly of claim 1 wherein said second end of said tether is attached to said tether adjacent said second end to form a tether loop, said tether loop releasably connectable to said tether connecting arrangement.

5. The assembly of claim 1 wherein said second end of said tether includes a ring attached thereto, said ring releasably connectable to said tether connecting arrangement.

6. The assembly of claim 1 wherein said restraint harness comprises a body restraint harness configured to be secured about shoulder and waist areas of said user.

7. The assembly of claim 6 wherein said body restraint harness is further configured to be secured about upper leg areas of said user.

8. The assembly of claim 1 wherein said tether connecting end of said retractable web is attached to said retractable web adjacent to said tether connecting end thereof to define a web loop.

9. The assembly of claim 8 wherein said tether connecting arrangement includes:
a caribeener received within said web loop and having two adjacent ends defining a space therebetween sized to receive said second end of said tether within said caribeener; and
a nut releasably connectable to each of said adjacent ends of said caribeener to trap said second end of said tether within said caribeener.

10. The assembly of claim 9 wherein said second end of said tether is attached to said tether adjacent said second end to form a tether loop, said tether loop received within said caribeener via said space and releasably connected to said caribeener via said cap.

11. The assembly of claim 9 wherein said second end of said tether includes a ring attached thereto, said ring received within said caribeener via said space and releasably connectable to said caribeener via said cap.

12. The assembly of claim 8 wherein said tether connecting arrangement includes an articulating connector having a frame portion defining a slot sized to receive said web loop therethrough, and an articulating jaw configured to releasably trap said second end of said tether therein.

13. The assembly of claim 12 wherein said articulating connector includes an actuator operable to actuate said articulating jaw between open and closed jaw positions.

14. The assembly of claim 13 wherein said second end of said tether is attached to said tether adjacent said second end to form a tether loop, said tether loop received within said articulating jaw and releasably connected to said articulating connector via said actuator.

15. The assembly of claim 13 wherein said second end of said tether includes a ring attached thereto, said ring received within said articulating jaw and releasably connected to said articulating connector via said actuator.

16. The assembly of claim 1 wherein said support surface is a tree.

17. A retractable safety harness and tether assembly, comprising:
a retractor having a retractable web defining a tether connecting end;
a tether having a first end connected to said tether connecting end of said retractable web, and a second opposite end attached to a restraint harness configured to be secured to a user; and
a retractor connecting arrangement securing said retractor to a support structure, said retractor connecting arrangement including a support web secured to said support structure and a retractor mounting structure secured to said support web, said retractor mountable to said retractor mounting structure.

18. The assembly of claim 17 wherein said support structure is a tree.

19. The assembly of claim 17 wherein said retractor defines a bore therethrough;
and wherein said retractor mounting structure includes:
a ring receiving said support web therethrough and secured to said support structure via said support web;
a caribeener having two adjacent ends defining a space therebetween sized to receive said ring within said caribeener, and at least one of said two adjacent ends sized to be received within said bore of said retractor; and
a nut releasably connectable to each of said adjacent ends of said caribeener to secure said retractor to said ring.

20. The assembly of claim 17 wherein said retractor defines a bore therethrough;
and wherein said retractor mounting structure includes a bracket defining open slots at opposite ends thereof each receiving said support web therethrough, said bracket secured to said support structure via said support web, said bracket further defining a projection extending outwardly therefrom, said retractor mountable to said bracket with said projection of said bracket received within said bore of said retractor.

21. The assembly of claim 20 wherein said projection and said bore are configured such that said projection may be received within said bore with said retractor rotated to a first position relative to said bracket;
and wherein said retractor is securable to said bracket by thereafter rotating said retractor to a second different position relative to said bracket.

22. The assembly of claim 18 wherein said retractor mounting structure includes a portion of a tree stand secured to said tree via said support web.

23. The assembly of claim 22 wherein said retractor defines a bore therethrough;
and wherein said retractor mounting structure includes a fixation member extending through said bore of said retractor into engagement with said portion of said tree stand to thereby secure said retractor to said tree stand.

24. The assembly of claim 17 wherein said retractor is a locking retractor responsive to predefined movement of said retractable web relative to said retractor to inhibit further movement of said retractable web relative to said retractor.

25. The assembly of claim 17 wherein said tether includes a gathered excess of tether between said first and second opposite ends thereof, said gathered excess of tether releasable to thereby increase a length of said tether.

26. The assembly of claim 17 wherein said restraint harness comprises a body restraint harness configured to be secured about shoulder and waist areas of said user.

27. The assembly of claim 26 wherein said body restraint harness is further configured to be secured about upper leg areas of said user.

28. A retractable safety harness and tether assembly, comprising:
a tree scaling aid including a first frame having a first end configured to engage a first side of a tree and a second opposite end, and a second frame having a first end configured to engage a second opposite side of the tree and a second opposite end movably connected to said second end of said first frame, said second frame movable relative to said first frame such that said first end of said second frame engages successively higher portions of the tree to aid in scaling the tree;
a retractor mounted to said first frame between said first and second ends thereof, said retractor having a retractable web defining a tether connecting end; and
a tether having a first end attached to a restraint harness configured to be secured to a user, and a second opposite end connectable to said tether connecting end of said retractable web.

29. The assembly of claim 28 wherein said retractor is a locking retractor responsive to predefined movement of said retractable web relative to said retractor to inhibit further movement of said retractable web relative to said retractor.

30. The assembly of claim 28 wherein said tether includes a gathered excess of tether between said first and second opposite ends thereof, said gathered excess of tether releasable to thereby increase a length of said tether.

31. The assembly of claim 28 wherein said restraint harness comprises a body restraint harness configured to be secured about shoulder and waist areas of said user.

32. The assembly of claim 31 wherein said body restraint harness is further configured to be secured about upper leg areas of said user.

33. The assembly of claim 28 wherein said tether connecting end of said retractable web is attached to said retractable web adjacent to said tether connecting end thereof to define a web loop.

34. The assembly of claim 33 further including:
a caribeener received within said web loop and having two adjacent ends defining a space therebetween sized to receive said second end of said tether within said caribeener; and
a nut releasably connectable to each of said adjacent ends of said caribeener to trap said second end of said tether within said caribeener.

35. The assembly of claim 34 wherein said second end of said tether is attached to said tether adjacent said second end to form a tether loop, said tether loop received within said caribeener via said space and releasably connected to said caribeener via said cap.

36. The assembly of claim 34 wherein said second end of said tether includes a ring attached thereto, said ring received within said caribeener via said space and releasably connectable to said caribeener via said cap.

37. The assembly of claim 33 further including an articulating connector having a frame portion defining a slot sized to receive said web loop therethrough, and an articulating jaw configured to releasably trap said second end of said tether therein.

38. The assembly of claim 37 wherein said articulating connector includes an actuator operable to actuate said articulating jaw between open and closed jaw positions.

39. The assembly of claim 38 wherein said second end of said tether is attached to said tether adjacent said second end to form a tether loop, said tether loop received within said articulating jaw and releasably connected to said articulating connector via said actuator.

40. The assembly of claim 38 wherein said second end of said tether includes a ring attached thereto, said ring received within said articulating jaw and releasably connected to said articulating connector via said actuator.
